(19) United States
(12) Patent Application Publication
(10) Pub. No.: US 2023/0275650 A1
(43) Pub. Date: Aug. 31, 2023

(54) DATA TRANSMISSION METHOD AND APPARATUS BASED ON SATELLITE COMMUNICATION, AND STORAGE MEDIUM

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/003,729

(22) PCT Filed: Jul. 9, 2020
(86) PCT No.: PCT/CN2020/101117

§ 371 Date: Dec. 29, 2022

(51) Int. Cl. H04B 7/185

(52) U.S. Cl. CPC H04B 7/18513; H04B 7/18519

(57) ABSTRACT

A data transmission method, apparatus and computer readable storage medium that improve the reliability and efficiency of data transmission. The reliability and efficiency of data transmission are improved by determining one or more demodulation performance parameters for demodulating data received through a satellite; reporting target indication information determined according to the demodulation performance parameters to the satellite, wherein the target indication information is configured to instruct the satellite to update one or more transmission parameters for the terminal performing data transmission; and performing data transmission with the satellite according to updated one or more target transmission parameters transmitted by the satellite.

### CROSS REFERENCE TO RELATED APPLICATIONS

This application is the national phase of International Application No. PCT/CN2020/101117 filed on Jul. 9, 2020, the disclosure of which is hereby incorporated by reference in its entirety.

### TECHNICAL FIELD

The present disclosure relates to the field of communication technologies, and in particular to a data transmission method and apparatus based on satellite communication, and a storage medium.

### BACKGROUND

In the research of wireless communication technologies, satellite communication is considered as an important aspect of the development of the wireless communication technologies in the future. Satellite communication refers to communication performed by radio communication equipment on the ground, for example, terminals, by using satellites as relays. A satellite communication system consists of a satellite part and a ground part. Characteristics of satellite communication include: a relatively large range of communication, that can be performed between any two points as long as the two points are within a range covered by radio waves emitted by the satellites; and it is not easily affected by land disasters, and thus the reliability of satellite communication is relatively high. In addition, as a supplement to a current cellular communication system on the ground, benefits of satellite communication are also obvious.

In the cellular communication system, in order to ensure the reliability of data transmission, a mechanism of a Hybrid Automatic Repeat reQuest (HARQ) feedback is introduced. That is, after a transmitting end transmits data to a receiving end, it is necessary for the receiving end to perform the HARQ feedback at a predefined or indicated resource location to inform the transmitting end whether the transmitted data is correctly received.

For the satellite communication system, since a distance between satellites with terminals is relatively long, if the mechanism based on HARQ feedback is used for transmission in the process of transmission, the latency of the data transmission will be very large, and the cache design of the terminals will also be greatly affected. However, if the HARQ feedback is not performed, the transmitting end will not know whether the receiving end has received the data, and the performance of the satellite communication system will also be affected.

### SUMMARY

According to a first aspect of the embodiments of the present disclosure, there is provided a data transmission method based on satellite communication, performed by a terminal, including:

determining one or more demodulation performance parameters for demodulating data received through a satellite;

reporting target indication information determined according to the demodulation performance parameters to the satellite, where the target indication information is configured to instruct the satellite to update one or more transmission parameters for the terminal performing data transmission; and

performing data transmission with the satellite according to updated one or more target transmission parameters transmitted by the satellite.

According to a second aspect of the embodiments of the present disclosure, there is provided a data transmission method based on satellite communication, performed by a satellite, including:

receiving target indication information determined according to one or more demodulation performance parameters reported by a terminal, where the demodulation performance parameters are performance parameters for the terminal demodulating data received through the satellite;

updating one or more transmission parameters for the terminal performing data transmission according to the target indication information to determine updated one or more target transmission parameters; and

transmitting the target transmission parameters to the terminal.

According to a third aspect of the embodiments of the present disclosure, there is provided a computer readable storage medium storing a computer program, where the computer program is configured to execute the data transmission method based on satellite communication described in any one of the above first aspects.

According to a fourth aspect of the embodiments of the present disclosure, there is provided a computer readable storage medium storing a computer program, where the computer program is configured to execute the data transmission method based on satellite communication described in any one of the above second aspects.

According to a fifth aspect of the embodiments of the present disclosure, there is provided a terminal, including:

a processor; and

a memory for storing instructions executable by the processor,

where the processor is configured to:

determine one or more demodulation performance parameters for demodulating data received through a satellite;

report target indication information determined according to the demodulation performance parameters to the satellite, where the target indication information is configured to instruct the satellite to update one or more transmission parameters for the terminal performing data transmission; and

perform data transmission with the satellite according to updated one or more target transmission parameters transmitted by the satellite.

According to a sixth aspect of the embodiments of the present disclosure, there is provided a satellite, including:

a processor; and

a memory for storing instructions executable by the processor,

where the processor is configured to:

receive target indication information determined according to one or more demodulation performance parameters reported by a terminal, where the demodulation performance parameters are performance parameters for the terminal demodulating data received through the satellite;

update one or more transmission parameters for the terminal performing data transmission according to the target indication information to determine updated one or more target transmission parameters; and

transmit the target transmission parameters to the terminal.

It should be understood that the above general descriptions and subsequent detailed descriptions are merely illustrative and explanatory, and shall not constitute limitations to the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a schematic flowchart illustrating a data transmission method based on satellite communication according to an embodiment.

FIG. 2 is a schematic flowchart illustrating a data transmission method based on satellite communication according to an embodiment.

FIG. 3 is a schematic flowchart illustrating a data transmission method based on satellite communication according to an embodiment.

FIG. 4 is a schematic flowchart illustrating a data transmission method based on satellite communication according to an embodiment.

FIG. 5 is a schematic flowchart illustrating a data transmission method based on satellite communication according to an embodiment.

FIG. 6 is a schematic flowchart illustrating a data transmission method based on satellite communication according to an embodiment.

FIG. 7 is a schematic flowchart illustrating a data transmission method based on satellite communication according to an embodiment.

FIG. 8A is a schematic diagram illustrating a data transmission scenario based on satellite communication according to an embodiment.

FIG. 8B is a schematic diagram illustrating a data transmission scenario based on satellite communication according to an embodiment.

FIG. 9 is a block diagram illustrating a data transmission apparatus based on satellite communication according to an embodiment.

FIG. 10 is a block diagram illustrating a data transmission apparatus based on satellite communication according to an embodiment.

FIG. 11 is a block diagram illustrating a data transmission apparatus based on satellite communication according to an embodiment.

FIG. 12 is a block diagram illustrating a data transmission apparatus based on satellite communication according to an embodiment.

FIG. 13 is a block diagram illustrating a data transmission apparatus based on satellite communication according to an embodiment.

FIG. 14 is a block diagram illustrating a data transmission apparatus based on satellite communication according to an embodiment.

FIG. 15 is a block diagram illustrating a data transmission apparatus based on satellite communication according to an embodiment.

FIG. 16 is a block diagram illustrating a data transmission apparatus based on satellite communication according to an embodiment.

FIG. 17 is a block diagram illustrating a data transmission apparatus based on satellite communication according to an embodiment.

FIG. 18 is a block diagram illustrating a data transmission apparatus based on satellite communication according to an embodiment.

FIG. 19 is a block diagram illustrating a data transmission apparatus based on satellite communication according to an embodiment.

FIG. 20 is a block diagram illustrating a data transmission apparatus based on satellite communication according to an embodiment.

FIG. 21 is a block diagram illustrating a data transmission apparatus based on satellite communication according to an embodiment.

FIG. 22 is a block diagram illustrating a data transmission apparatus based on satellite communication according to an embodiment.

FIG. 23 is a schematic structural diagram illustrating an electronic device according to an embodiment.

FIG. 24 is a schematic structural diagram illustrating a data transmission apparatus based on satellite communication according to an embodiment.

### DETAILED DESCRIPTION OF THE EMBODIMENTS

Embodiments will be described in detail here, examples of which are illustrated in the accompanying drawings. When the following description refers to the drawings, unless otherwise indicated, the same numerals in different drawings indicate the same or similar elements. The implementations set forth in the following description of embodiments do not represent all implementations consistent with the embodiments of the present disclosure. Instead, they are merely examples of apparatuses and methods consistent with aspects related to the embodiments of the present disclosure as recited in the appended claims.

Terms used in the embodiments of the present disclosure are only adopted for the purpose of describing specific embodiments and are not intended to limit the embodiments of the present disclosure. The singular forms “a,” “one,” and “the” used in the present disclosure and the appended claims are also intended to include plural forms, unless the context clearly indicates other meanings. It should also be understood that the term “and/or,” as used in the present disclosure refers to and includes any and all possible combinations of one or more of the associated listed items.

It should be understood that, although terms first, second, third, and the like may be adopted to describe various information in the embodiments of the present disclosure, the information should not be limited to these terms. These terms are only used to distinguish the same type of information. For example, the first information may also be referred to as second information, and similarly, the second information may also be referred to as the first information without departing from the scope of the embodiments of the present disclosure. For example, the terms “if” and “in case of” used herein may be explained as “while,” “when,” or “in response to determining,” which depends on the context.

Hereinafter, a data transmission method based on satellite communication provided by the embodiments of the present disclosure will be described from a terminal side.

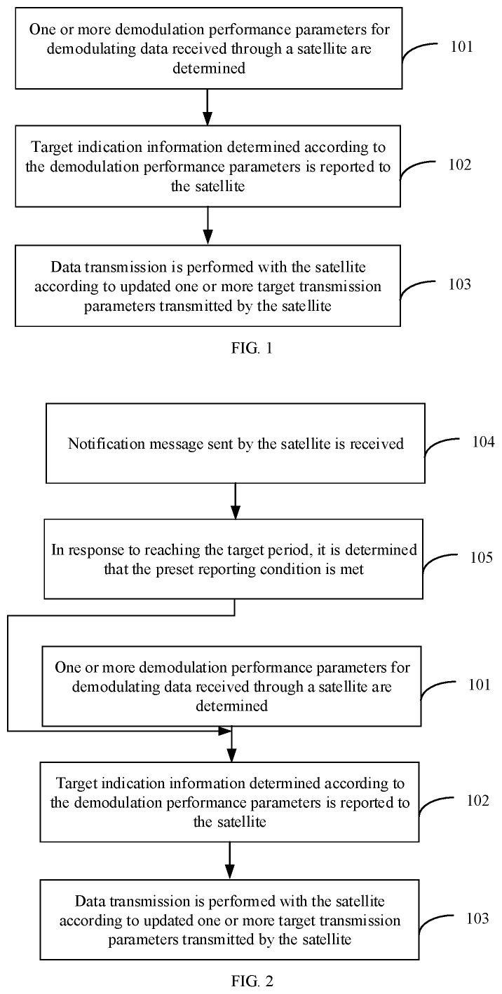

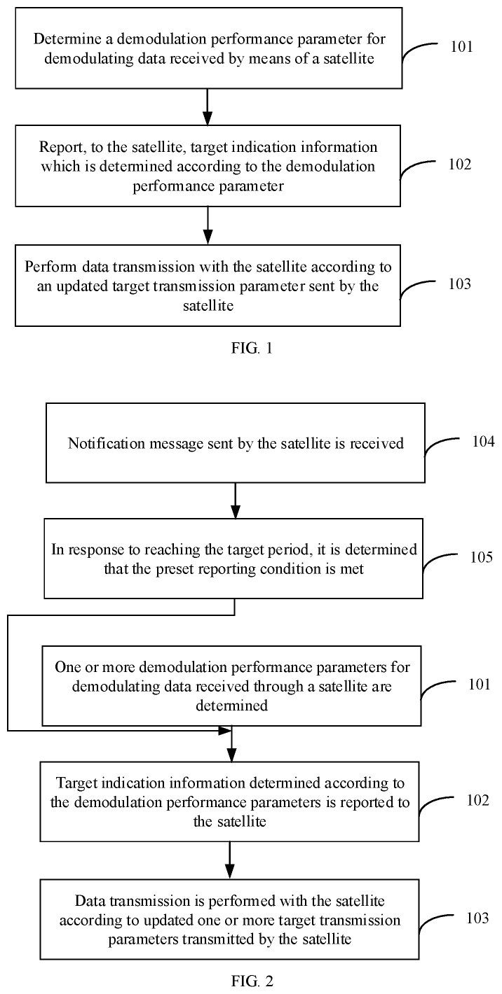

The embodiments of the present disclosure provide a data transmission method based on satellite communication, performed by a terminal. Referring to FIG. 1, FIG. 1 is a schematic flowchart illustrating a data transmission method based on satellite communication according to an embodiment. The method can include the following steps.

In step 101, one or more demodulation performance parameters for demodulating data received through a satellite are determined.

The demodulation performance parameters include at least one of the following:

first indication information for indicating whether downlink data is correctly received, second indication information for indicating a number of physical downlink shared channels (PDSCHs) carrying the downlink data that are correctly and/or incorrectly received, third indication information for indicating a proportion of the PDSCHs carrying the downlink data that are correctly and/or incorrectly received, or fourth indication information for indicating that downlink data packets are correctly and/or incorrectly received.

In step 102, target indication information determined according to the demodulation performance parameters is reported to the satellite.

The target indication information is configured to instruct the satellite to update one or more transmission parameters for the terminal performing data transmission.

In step 103, data transmission is performed with the satellite according to updated one or more target transmission parameters transmitted by the satellite.

The target transmission parameters include at least one of:

modulation and coding scheme information used for data transmission, resource information allocated for data transmission, power information of data transmission, or repetition number information of data transmission.

After receiving the updated target transmission parameters transmitted by the satellite, the terminal performs data transmission between the terminal and the satellite according to the target transmission parameters. The terminal performs the data transmission with the satellite includes that the terminal transmits data to the satellite and the terminal receives data transmitted by the satellite.

In the above embodiment, the terminal can report the target indication information determined according to the demodulation performance parameters to the satellite, where the demodulation performance parameters are performance parameters for the terminal demodulating data received through the satellite; and then the satellite can adjust the transmission parameters based on the target indication information, thereby improving the reliability and efficiency of data transmission during satellite communication.

In an alternative embodiment, for the above step 102, when a preset reporting condition is met, the terminal can report the target indication information to the satellite. The terminal can determine that the preset reporting condition is met based on any one of the following cases.

In the first case, when a target period is reached, the terminal can determine that the preset reporting condition is met.

FIG. 2 is a schematic flowchart illustrating a data transmission method based on satellite communication according to the embodiment shown in FIG. 1. The method can further include step 104.

In step 104, a notification message sent by the satellite is received.

The notification message includes at least a target period at which the terminal periodically reports the target indication information. After establishing a connection with the terminal, the satellite can send the notification message to the terminal.

In step 105, in response to reaching the target period, it is determined that the preset reporting condition is met.

In the embodiment of the present disclosure, when the target period is reached, the terminal can determine that the preset reporting condition is met, and automatically report the target indication information to the satellite.

In the second case, the terminal receives preset trigger signaling and/or a preset trigger signal transmitted by the satellite, and determines that the preset reporting condition is met.

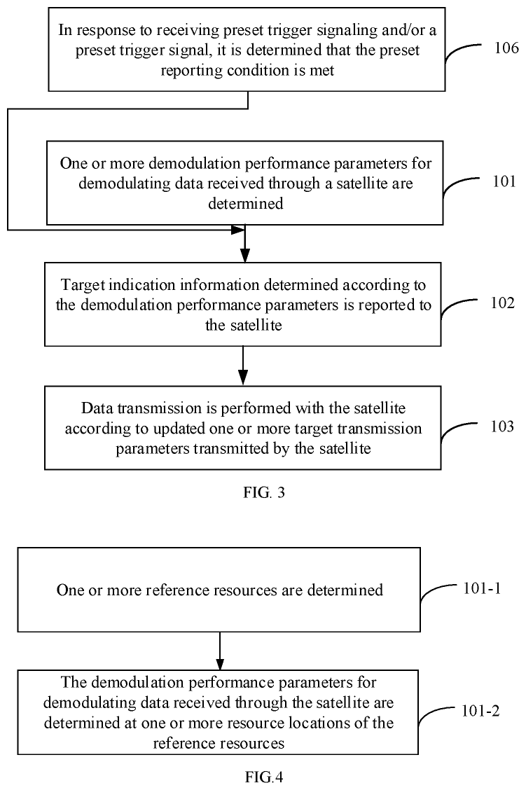

Referring to FIG. 3, FIG. 3 is a schematic flowchart illustrating a data transmission method based on satellite communication according to the embodiment shown in FIG. 1. The method can further include step 106.

In step 106, in response to receiving preset trigger signaling and/or a preset trigger signal, it is determined that the preset reporting condition is met.

In the embodiment of the present disclosure, the terminal can determine that the preset reporting condition is met based on the preset trigger signaling and/or preset trigger signal transmitted by the satellite, and automatically report the target indication information to the satellite.

In the above embodiment, the terminal can receive a notification message sent by the satellite, where the notification message includes at least a target period at which the terminal periodically reports the target indication information. Therefore, when the target period is reached, the terminal can determine that the preset reporting condition is met. Alternatively, the terminal can also determine that the preset reporting condition is met based on the triggering of signaling and/or the signal including, but not limited to, receiving preset trigger signaling and/or a preset trigger signal. In the embodiment of the present disclosure, when the preset reporting condition is met, the terminal can report the target indication information to the satellite, so that the satellite can adjust the transmission parameters based on the target indication information, thereby having high availability.

In an alternative embodiment, if the terminal reports the target indication information when the target period is reached, the notification message sent by the satellite to the terminal can further include at least one of the following:

a resource location when reporting the target indication information, or a preset format of signaling and/or signal for the terminal to perform uplink transmission.

Accordingly, step 102 can include at least one of the following:

reporting the target indication information to the satellite at the resource location indicated by the notification message; or reporting the target indication information in accordance with the preset format to the satellite.

In the embodiment of the present disclosure, the terminal can report the target indication information to the satellite according to the contents of the notification message sent by the satellite in advance, including but not limited to reporting the target indication information to the satellite at the resource location indicated by the notification message, and reporting the target indication information in accordance with the preset format to the satellite.

In the above embodiment, the terminal can report the target indication information to the satellite according to the contents indicated by the notification message, thereby having high availability.

In an alternative embodiment, if the terminal reports the target indication information based on the preset trigger signaling and/or preset trigger signal transmitted by the satellite, the preset trigger signaling and/or preset trigger signal transmitted by the satellite to the terminal needs to include at least the resource location when the target indication information is reported.

Accordingly, step 102 can include the following:

reporting the target indication information to the satellite at the resource location indicated by the preset trigger signaling and/or the preset trigger signal.

In the embodiment of the present disclosure, the terminal can report the target indication information to the satellite according to the resource location indicated by the preset trigger signaling and/or the preset trigger signal transmitted by the satellite.

In the above embodiment, the terminal can report the target indication information to the satellite according to contents indicated by the preset trigger signaling and/or the preset trigger signal, thereby having high availability.

In an alternative embodiment, referring to FIG. 4, FIG. 4 is a schematic flowchart illustrating a data transmission method based on satellite communication according to the embodiment shown in FIG. 1. Step 101 can include the following steps.

In step 101-1, one or more reference resources are determined.

In the embodiment of the present disclosure, the number of the reference resources can be one or more.

In an example, the terminal can determine one or more resources predefined in a protocol as the reference resources, or the terminal can receive resource indication signaling transmitted by the satellite and determine one or more resources indicated by the resource indication signaling as the reference resources. The resource indication signaling can be higher layer signaling including, but not limited to, radio resource control (RRC) signaling, or can be physical layer signaling including, but not limited to, media access control element (MACCE) signaling.

In another example, a time window can be predefined in the protocol. The time window can include a plurality of resources, and at least part of the resources included in the time window can be determined as a plurality of reference resources. Alternatively, time window indication signaling can be transmitted by the satellite, and at least part of the resources included in the time window indicated by the time window indication signaling can be determined as a plurality of reference resources. The time window indication signaling can be the higher layer signaling including, but not limited to, the radio resource control (RRC) signaling, or can be the physical layer signaling including, but not limited to, the media access control element (MACCE) signaling.

In step 101-2, the demodulation performance parameters for demodulating data received through the satellite are determined at one or more resource locations of the reference resources.

In the embodiment of the present disclosure, the time window can be absolute time information such as 1 second and 1 minute, or logical time information such as 1 symbol, 5 slots and 10 subframes. The demodulation performance parameters can be demodulation parameters of at least part of resources within a predefined time window.

The demodulation performance parameters can include at least one of the following:

first indication information for indicating whether downlink data is correctly received, second indication information for indicating a number of physical downlink shared channels (PDSCHs) carrying the downlink data that are correctly and/or incorrectly received, third indication information for indicating a proportion of the PDSCHs carrying the downlink data that are correctly and/or incorrectly received, or fourth indication information for indicating that downlink data packets are correctly and/or incorrectly received.

For example, in the time window predefined in the protocol, the terminal can determine the number of all received PDSCHs and the number of PDSCHs incorrectly received as the demodulation performance parameters. For another example, the terminal can determine the number of all received PDSCHs and the number of PDSCHs incorrectly received on a certain reference resource as the demodulation performance parameters.

In the above embodiment, the terminal can determine the demodulation performance parameters for demodulating data received through the satellite at one or more resource locations of one or more reference resources, where the one or more reference resources can be predefined in a protocol, or can be determined based on signaling transmitted by the satellite. According to the embodiments of the present disclosure, the terminal can automatically determine the demodulation performance parameters for demodulating data received through the satellite at one or more resource locations of the reference resources, and report the target indication information determined according to the demodulation performance parameters to the satellite, so that the satellite can adjust the transmission parameters, thereby improving the reliability and efficiency of data transmission during satellite communication.

In an alternative embodiment, for the above step 102, the terminal can be implemented in any one of the following manners.

In the first manner, the demodulation performance parameters are directly included in the target indication information, and the target indication information is reported to the satellite, so that the satellite can update the transmission parameters.

It is necessary for the first manner to carry more parameters, in order to reduce the overhead of the terminal, the target indication information can be reported to the satellite by using the following manner.

In the second manner, the terminal reports the target indication information including one or more first bit values to the satellite.

Referring to FIG. 5, FIG. 5 is a schematic flowchart illustrating a data transmission method based on satellite communication according to the embodiment shown in FIG. 1. Step 102 can include the following steps.

In step 102-1, a target update manner in which the terminal expects the satellite to update the transmission parameters is determined according to the demodulation performance parameters.

In the embodiment of the present disclosure, after determining the demodulation performance parameters, the terminal can determine the target update manner that the terminal expects the satellite to update the transmission parameters.

In step 102-2, one or more target bit values corresponding to the target update manner are determined according to a preset corresponding relationship between one or more bit values with update manners of the transmission parameters.

In an example, the target bit values can be represented by 1 bit of information. “0” represents that it is necessary to use a transmission parameter with higher transmission performance such as a modulation and coding scheme (MCS) or other transmission parameters, or a combination of multiple transmission parameters; and “1” represents that it is necessary to use a transmission parameter with lower transmission performance.

In another example, the target bit values can be represented by multiple bits of information. For example, “00” represents that it is suggested to use manner 1 to update the transmission parameters, “01” represents that it is suggested to use manner 2 to update the transmission parameters, “10” represents that it is suggested to use manner 3 to update the transmission parameters, and “11” represents that it is suggested to use manner 4 to update the transmission parameters.

In step 102-3, the target indication information including the target bit values is reported to the satellite.

In the embodiment of the present disclosure, for example, the terminal can report bit values of “1” or “0” to the satellite, or can report bit values of “00” or “10” to the satellite, and the satellite can determine the target update manner according to one or more target bit values to update the transmission parameters.

In the above embodiment, the terminal can directly report the target indication information including the demodulation performance parameters to the satellite, so that the satellite can adjust the transmission parameters according to the target indication information. Alternatively, the terminal can determine one or more target bit values according to the demodulation performance parameters, and then report the target indication information including the one or more target bit values, where the one or more target bit values correspond to the target update manner of the transmission parameters expected by the terminal, thereby reducing the reporting overhead of the terminal and having high availability.

Hereinafter, a data transmission method based on satellite communication provided by the embodiments of the present disclosure will be described from a satellite side.

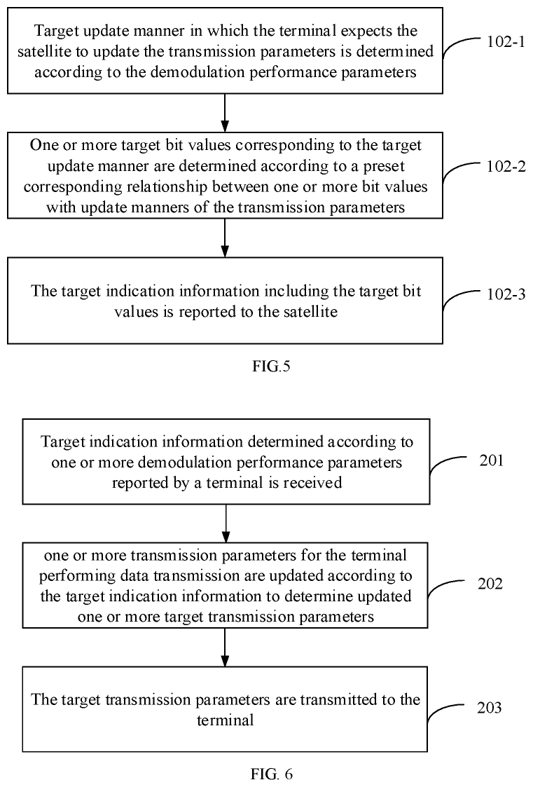

The embodiments of the present disclosure provide a data transmission method based on satellite communication, performed by a satellite. Referring to FIG. 6, FIG. 6 is a schematic flowchart illustrating a data transmission method based on satellite communication according to an embodiment. The method can include the following steps.

In step 201, target indication information determined according to one or more demodulation performance parameters reported by a terminal is received.

The demodulation performance parameters are performance parameters for the terminal demodulating data received through the satellite. The demodulation performance parameters can include at least one of the following:

first indication information for indicating whether downlink data is correctly received, second indication information for indicating a number of physical downlink shared channels (PDSCHs) carrying the downlink data that are correctly and/or incorrectly received, third indication information for indicating a proportion of the PDSCHs carrying the downlink data that are correctly and/or incorrectly received, or fourth indication information for indicating that downlink data packets are correctly and/or incorrectly received.

In step 202, one or more transmission parameters for the terminal performing data transmission are updated according to the target indication information to determine updated one or more target transmission parameters.

The target transmission parameters can include at least one of the following:

modulation and coding scheme information used for data transmission, resource information allocated for data transmission, power information of data transmission, or repetition number information of data transmission.

In step 203, the target transmission parameters are transmitted to the terminal.

In the embodiment of the present disclosure, the satellite can transmit the target transmission parameters to the terminal through one or more downlink scheduling instructions including, but not limited to, existing downlink control information (DCI) signaling, or signaling newly defined for downlink scheduling between the satellite and the terminal.

In the above embodiment, the satellite can adjust the transmission parameters based on the target indication information reported by the terminal, thereby improving the reliability and efficiency of data transmission during satellite communication.

In an alternative embodiment, for the above step 202, any one of the following manners can be used to determine the updated target transmission parameters.

In the first manner, the target transmission parameters are determined according to the demodulation performance parameters included in the target indication information.

In response to that the demodulation performance parameters included in the target indication information are greater than or equal to a preset threshold, one or more first transmission parameters are determined as the target transmission parameters; and in response to that the demodulation performance parameters included in the target indication information are less than the preset threshold, one or more second transmission parameters are determined as the target transmission parameters.

An efficiency of the first transmission parameters is higher than an efficiency of transmission parameters used between the terminal and the satellite before updating. In the embodiment of the present disclosure, if the demodulation performance parameters are greater than or equal to the preset threshold, the satellite can consider that the link condition is relatively good, and transmission parameters with higher efficiency can be used for data transmission. For example, the level of the MCS used for data transmission can be increased, a size of resources allocated to the terminal can be reduced, the power of data transmission can be reduced, and the repetition numbers of data transmission can be reduced.

An efficiency of the second transmission parameters is lower than the efficiency of the transmission parameters used between the terminal and the satellite before updating. In the embodiment of the present disclosure, if the demodulation performance parameters are less than the preset threshold, the satellite can consider that the link condition is relatively poor, and transmission parameters with lower efficiency can be used for data transmission. For example, the level of the MCS used for data transmission can be reduced, a size of resources allocated to the terminal can be increased, the power of data transmission can be increased, and the repetition numbers of data transmission can be increased.

In the second manner, the target transmission parameters are determined according to one or more target bit values included in the target indication information.

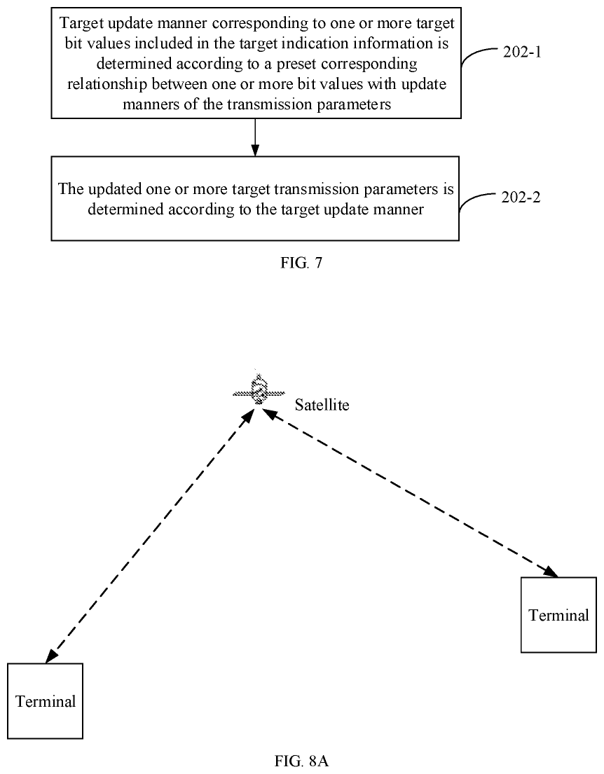

Referring to FIG. 7, FIG. 7 is a schematic flowchart illustrating a data transmission method based on satellite communication according to the embodiment shown in FIG. 6. Step 202 can include the following steps.

In step 202-1, a target update manner corresponding to one or more target bit values included in the target indication information is determined according to a preset corresponding relationship between one or more bit values with update manners of the transmission parameters.

In step 202-2, the updated one or more target transmission parameters is determined according to the target update manner.

For example, if the target update manner is to use the first transmission parameters with higher transmission efficiency, the first transmission parameters can be used as the target transmission parameters; otherwise, the second transmission parameters can be used as the target transmission parameters.

For another example, if different bit values correspond to update manners of different transmission parameters, transmission parameters corresponding to the target update manner can be used as target transmission parameters. In the above embodiment, the satellite can determine the target transmission parameters according to the demodulation performance parameters in the target indication information reported by the terminal, or can determine the target transmission parameters according to one or more target bit values in the target indication information, so that the terminal can perform data transmission according to the target transmission parameters, thereby improving the reliability and efficiency of data transmission during satellite communication.

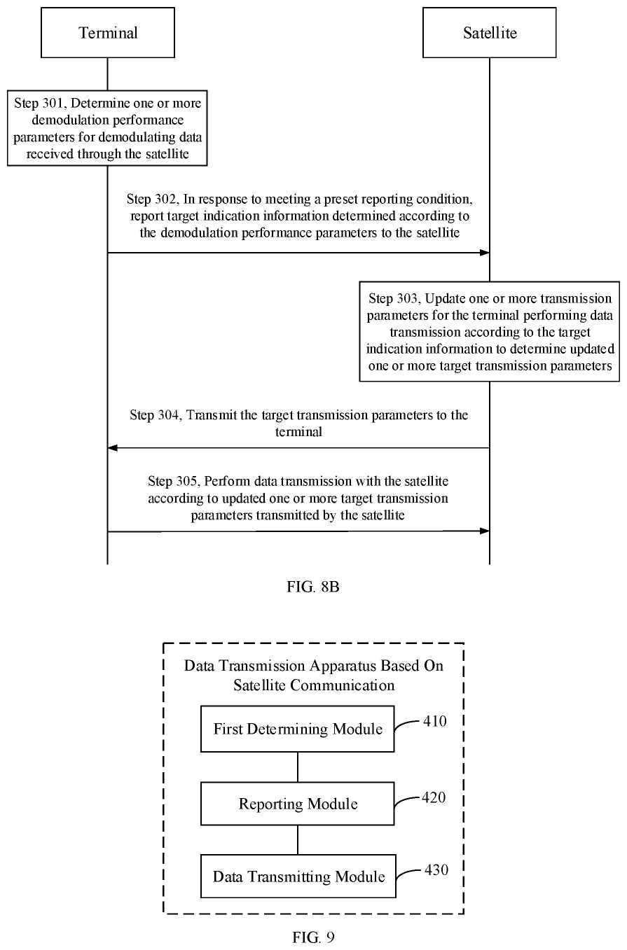

In an alternative embodiment, a scenario of satellite communication is shown in FIG. 8A, and terminals communicate with each other via a satellite. As shown in FIG. 8B, the data transmission method between the satellite and the terminal can include the following steps.

In step 301, the terminal determines one or more demodulation performance parameters for demodulating data received through the satellite.

In step 302, in response to meeting a preset reporting condition, the terminal reports target indication information determined according to the demodulation performance parameters to the satellite.

The target indication information is configured to instruct the satellite to update one or more transmission parameters for the terminal performing data transmission.

In step 303, the satellite updates one or more transmission parameters for the terminal performing data transmission according to the target indication information to determine updated one or more target transmission parameters.

In step 304, the satellite transmits the target transmission parameters to the terminal.

In step 305, the terminal performs data transmission with the satellite according to updated one or more target transmission parameters transmitted by the satellite.

The terminal performs data transmission with the satellite can include that the terminal transmits data to the satellite, and the terminal receives data transmitted by the satellite.

In the above embodiment, the terminal can report the target indication information determined according to the demodulation performance parameters to the satellite, where the demodulation performance parameters are performance parameters for the terminal demodulating data received through the satellite; and then the satellite can adjust the transmission parameters based on the target indication information, thereby improving the reliability and efficiency of data transmission during satellite communication.

Corresponding to the foregoing examples of an application function implementation method, the present disclosure further provides examples of an application function implementation apparatus.

Referring to FIG. 9, FIG. 9 is a block diagram illustrating a data transmission apparatus based on satellite communication according to an embodiment. The apparatus is applied to a terminal and includes the following:

a first determining module 410 configured to determine one or more demodulation performance parameters for demodulating data received through a satellite;

a reporting module 420 configured to report target indication information determined according to the demodulation performance parameters to the satellite, where the target indication information is configured to instruct the satellite to update one or more transmission parameters for the terminal performing data transmission; and

a data transmitting module 430 configured to perform data transmission with the satellite according to updated one or more target transmission parameters transmitted by the satellite.

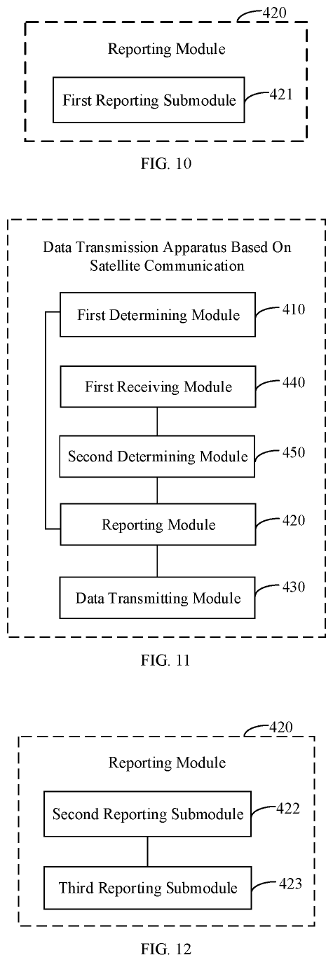

As shown in FIG. 10, FIG. 10 is a block diagram illustrating a data transmission apparatus based on satellite communication according to an embodiment. This embodiment is based on the aforementioned embodiment of FIG. 9, and the reporting module 420 includes:

a first reporting submodule 421 configured to, in response to meeting a preset reporting condition, report the target indication information to the satellite.

As shown in FIG. 11, FIG. 11 is a block diagram illustrating a data transmission apparatus based on satellite communication according to an embodiment. This embodiment is based on the aforementioned embodiment of FIG. 10, and the apparatus further includes:

a first receiving module 440 configured to receive a notification message sent by the satellite, where the notification message includes at least a target period at which the terminal periodically reports the target indication information; and

a second determining module 450 configured to, in response to reaching the target period, determine that the preset reporting condition is met.

In some examples, the notification message further includes at least one of the following:

a resource location when reporting the target indication information, or a preset format of signaling and/or signal for the terminal to perform uplink transmission.

As shown in FIG. 12, FIG. 12 is a block diagram illustrating a data transmission apparatus based on satellite communication according to an embodiment. This embodiment is based on the aforementioned embodiment of FIG. 11, and the reporting module 420 includes at least one of the following:

a second reporting submodule 422 configured to report the target indication information to the satellite at the resource location indicated by the notification message; or

a third reporting submodule 423 configured to report the target indication information in accordance with the preset format to the satellite.

As shown in FIG. 13, FIG. 13 is a block diagram illustrating a data transmission apparatus based on satellite communication according to an embodiment. This embodiment is based on the aforementioned embodiment of FIG. 10, and the apparatus further includes:

a third determining module 460 configured to, in response to receiving preset trigger signaling and/or a preset trigger signal, determine that the preset reporting condition is met.

In some examples, the preset trigger signaling and/or the preset trigger signal includes at least a resource location when reporting the target indication information.

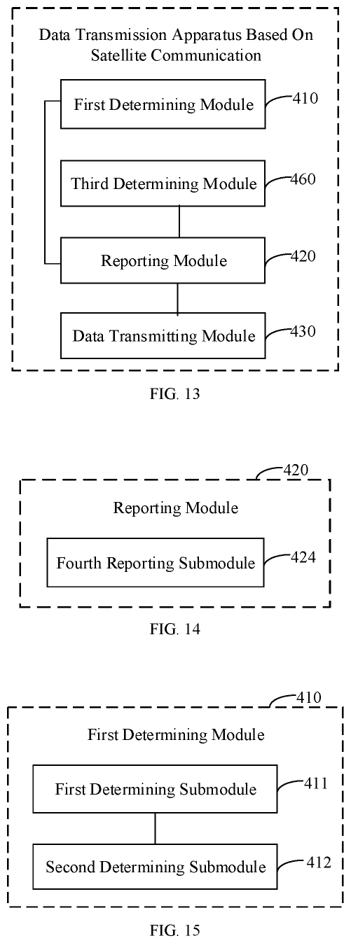

As shown in FIG. 14, FIG. 14 is a block diagram illustrating a data transmission apparatus based on satellite communication according to an embodiment. This embodiment is based on the aforementioned embodiment of FIG. 13, and the reporting module 420 includes:

a fourth reporting submodule 424 configured to report the target indication information to the satellite at the resource location indicated by the preset trigger signaling and/or the preset trigger signal.

As shown in FIG. 15, FIG. 15 is a block diagram illustrating a data transmission apparatus based on satellite communication according to an embodiment. This embodiment is based on the aforementioned embodiment of FIG. 9, and the first determining module 410 includes:

a first determining submodule 411 configured to determine one or more reference resources; and

a second determining submodule 412 configured to determine the demodulation performance parameters for demodulating data received through the satellite at one or more resource locations of the reference resources.

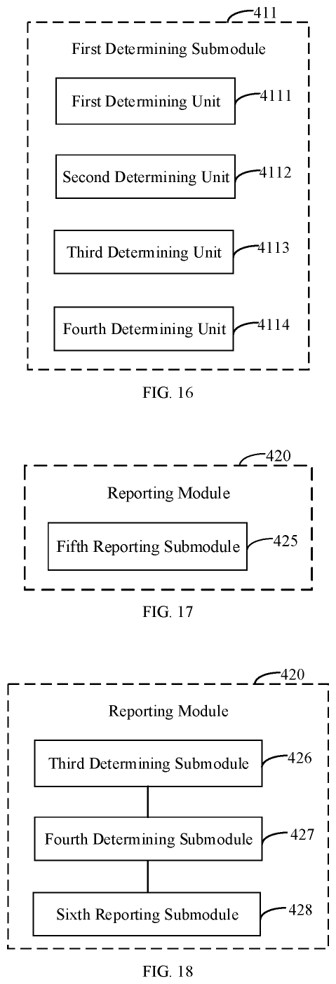

As shown in FIG. 16, FIG. 16 is a block diagram illustrating a data transmission apparatus based on satellite communication according to an embodiment. This embodiment is based on the aforementioned embodiment of FIG. 15, and the first determining submodule 411 includes any one of:

a first determining unit 4111 configured to determine one or more resources predefined in a protocol as the reference resources;

a second determining unit 4112 configured to determine at least part of resources included in a time window predefined in the protocol as a plurality of reference resources;

a third determining unit 4113 configured to, after receiving resource indication signaling transmitted by the satellite, determine one or more resources indicated by resource indication signaling as the reference resources; and

a fourth determining unit 4114 configured to, after receiving time window indication signaling transmitted by the satellite, determine at least part of resources included in the time window indicated by the time window indication signaling as a plurality of reference resources.

As shown in FIG. 17, FIG. 17 is a block diagram illustrating a data transmission apparatus based on satellite communication according to an embodiment. This embodiment is based on the aforementioned embodiment of FIG. 9, and the reporting module 420 includes:

a fifth reporting submodule 425 configured to report the target indication information including the demodulation performance parameters to the satellite.

As shown in FIG. 18, FIG. 18 is a block diagram illustrating a data transmission apparatus based on satellite communication according to an embodiment. This embodiment is based on the aforementioned embodiment of FIG. 9, and the reporting module 420 includes:

a third determining submodule 426 configured to determine a target update manner in which the terminal expects the satellite to update the transmission parameters according to the demodulation performance parameters;

a fourth determining submodule 427 configured to determine one or more target bit values corresponding to the target update manner according to a preset corresponding relationship between one or more bit values with update manners of the transmission parameters; and

a sixth reporting submodule 428 configured to report the target indication information including the target bit values to the satellite.

In some examples, the demodulation performance parameters include at least one of the following:

first indication information for indicating whether downlink data is correctly received, second indication information for indicating a number of physical downlink shared channels (PDSCHs) carrying the downlink data that are correctly and/or incorrectly received, third indication information for indicating a proportion of the PDSCHs carrying the downlink data that are correctly and/or incorrectly received, or fourth indication information for indicating that downlink data packets are correctly and/or incorrectly received; and

the target transmission parameters include at least one of the following:

modulation and coding scheme information used for data transmission, resource information allocated for data transmission, power information of data transmission, or repetition number information of data transmission.

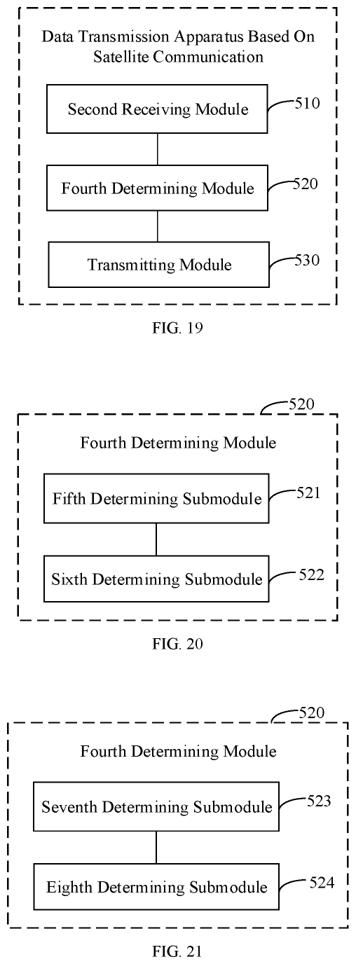

Referring to FIG. 19, FIG. 19 is a block diagram illustrating a data transmission apparatus based on satellite communication according to an embodiment. The apparatus is applied to a satellite and includes the following:

a second receiving module 510 configured to receive target indication information determined according to one or more demodulation performance parameters reported by a terminal, where the demodulation performance parameters are performance parameters for the terminal demodulating data received through the satellite;

a fourth determining module 520 configured to update one or more transmission parameters for the terminal performing data transmission to determine updated one or more target transmission parameters according to the target indication information; and

a transmitting module 530 configured to transmit the target transmission parameters to the terminal.

As shown in FIG. 20, FIG. 20 is a block diagram illustrating a data transmission apparatus based on satellite communication according to an embodiment. This embodiment is based on the aforementioned embodiment of FIG. 19, and the fourth determining module 520 includes:

a fifth determining submodule 521 configured to, in response to that the demodulation performance parameters included in the target indication information are greater than or equal to a preset threshold, determine one or more first transmission parameters as the target transmission parameters, where an efficiency of the first transmission parameters is higher than an efficiency of transmission parameters used between the terminal and the satellite before updating; and

a sixth determining submodule 522 configured to, in response to that the demodulation performance parameters included in the target indication information are less than the preset threshold, determine one or more second transmission parameters as the target transmission parameters, where an efficiency of the second transmission parameters is lower than the efficiency of the transmission parameters used between the terminal and the satellite before updating.

As shown in FIG. 21, FIG. 21 is a block diagram illustrating a data transmission apparatus based on satellite communication according to an embodiment. This embodiment is based on the aforementioned embodiment of FIG. 19, and the fourth determining module 520 includes:

a seventh determining submodule 523 configured to determine a target update manner corresponding to one or more target bit values included in the target indication information according to a preset corresponding relationship between one or more bit values with update manners of the transmission parameters; and

an eighth determining submodule 524 configured to determine the updated one or more target transmission parameters according to the target update manner.

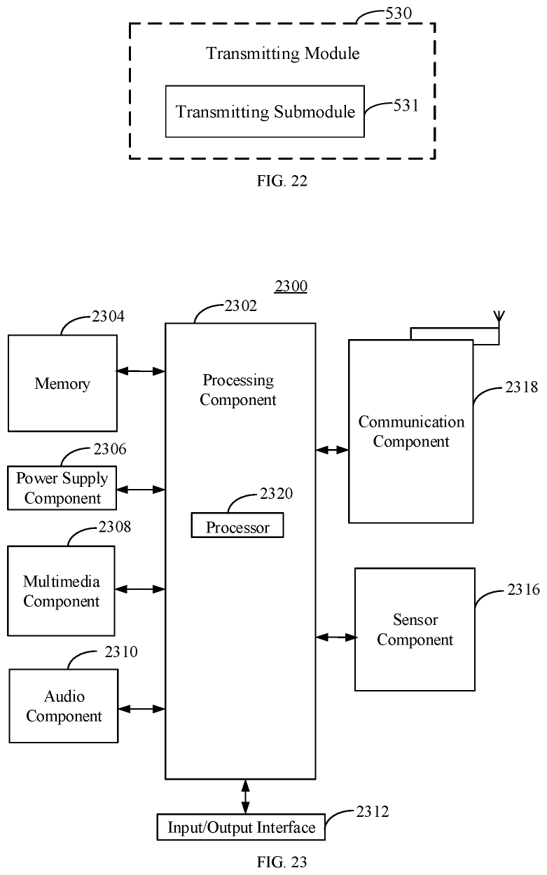

As shown in FIG. 22, FIG. 22 is a block diagram illustrating a data transmission apparatus based on satellite communication according to an embodiment. This embodiment is based on the aforementioned embodiment of FIG. 19, and the transmitting module 530 includes:

a transmitting submodule 531 configured to transmit the target transmission parameters to the terminal through downlink scheduling signaling.

In some examples, the demodulation performance parameters include at least one of the following:

first indication information for indicating whether downlink data is correctly received, second indication information for indicating a number of physical downlink shared channels (PDSCHs) carrying the downlink data that are correctly and/or incorrectly received, third indication information for indicating a proportion of the PDSCHs carrying the downlink data that are correctly and/or incorrectly received, or fourth indication information for indicating that downlink data packets are correctly and/or incorrectly received; and

the target transmission parameters include at least one of the following:

modulation and coding scheme information used for data transmission, resource information allocated for data transmission, power information of data transmission, or repetition number information of data transmission.

For the apparatus embodiment, since it basically corresponds to the method embodiment, the relevant part may refer to the part of the description of the method embodiment. The apparatus embodiments described above are merely illustrative, where the units described as separate components may or may not be physically separated, and the components displayed as units may or may not be physical units. That is, they may be located in one place or may be distributed to a plurality of network units. Some or all of the modules may be selected according to actual needs, to achieve the objectives of the solutions of the present disclosure. Those skilled in the art may understand and implement without creative labor.

Accordingly, the present disclosure further provides a computer readable storage medium storing a computer program, where the computer program is configured to execute the data transmission method based on satellite communication described in any one of the above embodiments performed by a terminal.

Accordingly, the present disclosure further provides a computer readable storage medium storing a computer program, where the computer program is configured to execute the data transmission method based on satellite communication described in any one of the above embodiments performed by a satellite.

Accordingly, the present disclosure further provides a terminal, including:

a processor; and

a memory for storing instructions executable by the processor,

where the processor is configured to:

determine one or more demodulation performance parameters for demodulating data received through a satellite;

report target indication information determined according to the demodulation performance parameters to the satellite, where the target indication information is configured to instruct the satellite to update one or more transmission parameters for the terminal performing data transmission; and

perform data transmission with the satellite according to updated one or more target transmission parameters transmitted by the satellite.

FIG. 23 is a schematic structural diagram illustrating an electronic device 2300 according to an embodiment. For example, the electronic device 2300 can be a terminal such as a mobile phone, a tablet computer, an e-book reader, a multimedia playback device, a wearable device, a vehicle-mounted terminal, an iPad®, a smart TV, and the like.

Referring to FIG. 23, the electronic device 2300 may include one or more of the following components: a processing component 2302, a memory 2304, a power supply component 2306, a multimedia component 2308, an audio component 2310, an input/output (I/O) interface 2312, a sensor component 2316 and a communication component 2318.

The processing component 2302 generally controls the overall operations of the electronic device 2300, such as operations associated with display, phone calls, data communications, camera operations, and recording operations. The processing component 2302 may include one or more processors 2320 to execute instructions to complete all or part of the steps of the above data transmission method based on satellite communication. In addition, the processing component 2302 may include one or more modules that facilitate the interaction between the processing component 2302 and other components. For example, the processing component 2302 may include a multimedia module to facilitate the interaction between the multimedia component 2308 and the processing component 2302. For another example, the processing component 2302 can read executable instructions from the memory to implement the steps of the data transmission method based on satellite communication provided by the above embodiments.

The memory 2304 is to store various types of data to support the operation of the electronic device 2300. Examples of such data include instructions for any application or method operated on the electronic device 2300, contact data, phonebook data, messages, pictures, videos, and so on. The memory 2304 may be implemented by any type of volatile or non-volatile storage devices or a combination thereof, such as a Static Random-Access Memory (SRAM), an Electrically-Erasable Programmable Read Only Memory (EEPROM), an Erasable Programmable Read Only Memory (EPROM), a Programmable read-only memory (PROM), a Read Only Memory (ROM), a magnetic memory, a flash memory, a magnetic or optical disk.

The power supply component 2306 provides power to different components of the electronic device 2300. The power supply component 2306 may include a power management system, one or more power supplies, and other components associated with generating, managing, and distributing power for the electronic device 2300.

The multimedia component 2308 includes a screen providing an output interface between the electronic device 2300 and a user. In some embodiments, the multimedia component 2308 may include a front camera and/or a rear camera. The front camera and/or rear camera may receive external multimedia data when the electronic device 2300 is in an operating mode, such as a photographing mode or a video mode. Each of the front camera and the rear camera may be a fixed optical lens system or have focal length and optical zooming capability.

The audio component 2310 is configured to output and/or input an audio signal. For example, the audio component 2310 includes a microphone (MIC). When the electronic device 2300 is in an operating mode, such as a call mode, a recording mode, and a voice recognition mode, the MIC is to receive an external audio signal. The received audio signal may be further stored in the memory 2304 or transmitted via the communication component 2318. In some embodiments, the audio component 2310 further includes a speaker to output an audio signal.

The I/O interface 2312 may provide an interface between the processing component 2302 and peripheral interface modules. The above peripheral interface modules may include a keyboard, a click wheel, buttons, and so on. These buttons may include, but are not limited to, a home button, a volume button, a starting button, and a locking button.

The sensor component 2316 includes one or more sensors to provide status assessments of various aspects of the electronic device 2300. For example, the sensor component 2316 may detect the on/off status of the electronic device 2300, and the relative positioning of the component. For example, the component is a display and a keypad of the electronic device 2300. The sensor component 2316 may also detect a change in the position of the electronic device 2300 or a component of the electronic device 2300, a presence or absence of the contact between a user and the electronic device 2300, an orientation or an acceleration/deceleration of the electronic device 2300, and a change in temperature of the electronic device 2300. The sensor component 2316 may include a proximity sensor to detect the presence of a nearby object without any physical contact. The sensor component 2316 may further include an optical sensor, such as a Complementary Metal Oxide Semiconductor (CMOS) or Charge-coupled Device (CCD) image sensor, which is used in imaging applications. In some embodiments, the sensor component 2316 may further include an acceleration sensor, a gyroscope sensor, a magnetic sensor, a pressure sensor, or a temperature sensor.

The communication component 2318 is configured to facilitate wired or wireless communication between the electronic device 2300 and other devices. The electronic device 2300 may access a wireless network that is based on a communication standard, such as Wi-Fi, 2G, 3G, 4G or 5G, or a combination thereof. In an embodiment, the communication component 2318 receives a broadcast signal or broadcast-associated information from an external broadcast management system via a broadcast channel. In an embodiment, the communication component 2318 further includes a Near Field Communication (NFC) module to facilitate short-range communications. For example, the NFC module may be implemented based on a Radio Frequency Identification (RFID) technology, an Infrared Data Association (IrDA) technology, an Ultra-Wide Band (UWB) technology, a Blue Tooth (BT) technology and other technologies.

In an embodiment, the electronic device 2300 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components for performing the above data transmission method based on satellite communication.

In an embodiment, there is also provided a non-transitory computer readable storage medium including instructions, such as the memory 2304 including instructions. The instructions may be executed by the processor 2320 of the electronic device 2300 to perform the above data transmission method based on satellite communication. For example, the non-transitory computer readable storage medium may be a ROM, a Random Access Memory (RAM), a CD-ROM, a magnetic tape, a floppy disk, an optical data storage device, and the like.

Accordingly, the present disclosure further provides a satellite, including:

a processor; and

a memory for storing instructions executable by the processor,

where the processor is configured to:

receive target indication information determined according to one or more demodulation performance parameters reported by a terminal, where the demodulation performance parameters are performance parameters for the terminal demodulating data received through the satellite;

update one or more transmission parameters for the terminal performing data transmission to determine updated one or more target transmission parameters according to the target indication information; and

transmit the target transmission parameters to the terminal.

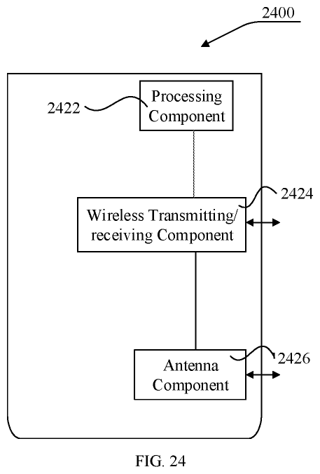

As shown in FIG.24, FIG. 24 is a schematic structural diagram illustrating a data transmission apparatus based on satellite communication according to an embodiment. The apparatus 2400 can be provided as a satellite. Referring to FIG. 24, the apparatus 2400 includes a processing component 2422, a wireless transmitting/receiving component 2424, an antenna component 2426 and a signal processing part specific to a wireless interface. The processing component 2422 can further include one or more processors.

One of the processors in the processing component 2422 can be configured to implement the data transmission method based on satellite communication described in any one of the above embodiments performed by the satellite side.

Other implementations of the present disclosure will be apparent to those skilled in the art from consideration of the specification and practice of the present disclosure herein. The present disclosure is intended to cover any variations, uses, modifications or adaptations of the present disclosure that follow the general principles thereof and include common knowledge or conventional technical means in the art that are not disclosed in the present disclosure. The specification and examples are considered as exemplary only, with a true scope and spirit of the present disclosure being indicated by the following claims.

It should be understood that the present disclosure is not limited to the above described structures shown in the drawings, and various modifications and changes can be made to the present disclosure without departing from the scope thereof. The scope of the present disclosure is to be limited only by the appended claims.

1. A data transmission method based on satellite communication, performed by a terminal, comprising:
determining one or more demodulation performance parameters for demodulating data received through a satellite;
reporting target indication information determined according to the demodulation performance parameters to the satellite, wherein the target indication information is configured to instruct the satellite to update one or more transmission parameters for the terminal performing data transmission; and
performing data transmission with the satellite according to updated one or more target transmission parameters transmitted by the satellite.

2. The method according to claim 1, wherein reporting the target indication information determined according to the demodulation performance parameters to the satellite comprises:
in response to meeting a preset reporting condition, reporting the target indication information to the satellite.

3. The method according to claim 2, further comprising:
receiving a notification message sent by the satellite, wherein the notification message comprises at least a target period at which the terminal periodically reports the target indication information; and
in response to reaching the target period, determining that the preset reporting condition is met.

4. The method according to claim 3, wherein the notification message further comprises at least one of:
a resource location when reporting the target indication information, or a preset format of signaling and/or signal for the terminal to perform uplink transmission; and
reporting the target indication information determined according to the demodulation performance parameters to the satellite comprises at least one of:
reporting the target indication information to the satellite at the resource location indicated by the notification message; or
reporting the target indication information in accordance with the preset format to the satellite.

5. The method according to claim 2, further comprising:
in response to receiving preset trigger signaling and/or a preset trigger signal, determining that the preset reporting condition is met.

6. The method according to claim 5, wherein the preset trigger signaling and/or the preset trigger signal comprises at least a resource location when reporting the target indication information; and
reporting the target indication information determined according to the demodulation performance parameters to the satellite comprises:
reporting the target indication information to the satellite at the resource location indicated by the preset trigger signaling and/or the preset trigger signal.

7. The method according to claim 1, wherein the determining the one or more demodulation performance parameters for demodulating data received through the satellite comprises:
determining one or more reference resources; and
determining the demodulation performance parameters for demodulating data received through the satellite at one or more resource locations of the reference resources.

8. The method according to claim 7, wherein determining the reference resources comprises any one of:
determining one or more resources predefined in a protocol as the reference resources;
determining at least part of resources comprised in a time window predefined in the protocol as a plurality of reference resources;
after receiving resource indication signaling transmitted by the satellite, determining one or more resources indicated by the resource indication signaling as the reference resources;
after receiving time window indication signaling transmitted by the satellite, determining at least part of resources comprised in the time window indicated by the time window indication signaling as a plurality of reference resources.

9. The method according to claim 1, wherein reporting the target indication information determined according to the demodulation performance parameters to the satellite comprises:
reporting the target indication information comprising the demodulation performance parameters to the satellite.

10. The method according to claim 1, wherein reporting the target indication information determined according to the demodulation performance parameters to the satellite comprises:
determining a target update manner in which the terminal expects the satellite to update the transmission parameters according to the demodulation performance parameters;
determining one or more target bit values corresponding to the target update manner according to a preset corresponding relationship between one or more bit values with update manners of the transmission parameters; and
reporting the target indication information comprising the target bit values to the satellite.

11. The method according to claim 1, wherein the demodulation performance parameters comprise at least one of:
first indication information for indicating whether downlink data is correctly received, second indication information for indicating a number of physical downlink shared channels (PDSCHs) carrying the downlink data that are correctly and/or incorrectly received, third indication information for indicating a proportion of the PDSCHs carrying the downlink data that are correctly and/or incorrectly received, or fourth indication information for indicating that downlink data packets are correctly and/or incorrectly received; and
the target transmission parameters comprise at least one of:
modulation and coding scheme information used for data transmission, resource information allocated for data transmission, power information of data transmission, or repetition number information of data transmission.

12. A data transmission method based on satellite communication, performed by a satellite, comprising:
receiving target indication information determined according to one or more demodulation performance parameters reported by a terminal, wherein the demodulation performance parameters are performance parameters for the terminal demodulating data received through the satellite;
updating one or more transmission parameters for the terminal performing data transmission according to the target indication information to determine updated one or more target transmission parameters; and
transmitting the target transmission parameters to the terminal.

13. The method according to claim 12, wherein the updating the one or more transmission parameters for the terminal performing data transmission according to the target indication information to determine the one or more target transmission parameters to update comprises:
in response to that the demodulation performance parameters comprised in the target indication information are greater than or equal to a preset threshold, determining one or more first transmission parameters as the target transmission parameters, wherein an efficiency of the first transmission parameters is higher than an efficiency of transmission parameters used between the terminal and the satellite before updating; and
in response to that the demodulation performance parameters comprised in the target indication information are less than the preset threshold, determining one or more second transmission parameters as the target transmission parameters, wherein an efficiency of the second transmission parameters is lower than the efficiency of the transmission parameters used between the terminal and the satellite before updating.

14. The method according to claim 12, wherein the updating the one or more transmission parameters for the terminal performing data transmission according to the target indication information to determine the one or more target transmission parameters to update comprises:
determining a target update manner corresponding to one or more target bit values comprised in the target indication information according to a preset corresponding relationship between one or more bit values with update manners of the transmission parameters; and
determining the updated one or more target transmission parameters according to the target update manner.

15. The method according to claim 12, wherein transmitting the target transmission parameters to the terminal comprises:
transmitting the target transmission parameters to the terminal through downlink scheduling signaling.

16. The method according to claim 12 wherein the demodulation performance parameters comprise at least one of:
first indication information for indicating whether downlink data is correctly received, second indication information for indicating a number of physical downlink shared channels (PDSCHs) carrying the downlink data that are correctly and/or incorrectly received, third indication information for indicating a proportion of the PDSCHs carrying the downlink data that are correctly and/or incorrectly received, or fourth indication information for indicating that downlink data packets are correctly and/or incorrectly received; and
the target transmission parameters comprise at least one of:
modulation and coding scheme information used for data transmission, resource information allocated for data transmission, power information of data transmission, or repetition number information of data transmission.

17-32. (canceled)

33. A computer readable storage medium storing a computer program, wherein the computer program when executed by a processor causes the processor to execute the method accorthng to claim 1.

34. A computer readable storage medium storing a computer program, wherein the computer program when executed by a processor causes the processor to execute the method according to claim 12.

35. A terminal, comprising:
a processor; and
a memory for storing instructions executable by the processor,
wherein the instructions when executed by the processor cause the processor to:
determine one or more demodulation performance parameters for demodulating data received through a satellite;
report target indication information determined according to the demodulation performance parameters to the satellite, wherein the target indication information is configured to instruct the satellite to update one or more transmission parameters for the terminal performing data transmission; and
perform data transmission with the satellite according to updated one or more target transmission parameters transmitted by the satellite.

36. A satellite, comprising:
a processor; and
a memory for storing instructions executable by the processor,
wherein the instructions when executed by a processor cause the processor to execute the data transmission method based on satellite communication according to claim 12.
